(19) United States
(12) Patent Application Publication
(10) Pub. No.: US 2007/0043588 A1
(43) Pub. Date: Feb. 22, 2007

(54) Environmental management plans

(76) Inventor: Terry John Muir, New South Wales (AU)

Correspondence Address: KING & SCHICKLI, PLLC, 247 NORTH BROADWAY, LEXINGTON, KY, 40507, US

(21) Appl. No.: 11/522,619

(22) Filed: Sep. 18, 2006

Related U.S. Application Data
(63) Continuation of application No. PCT/AU04/00876, filed on Jun. 22, 2004.

(30) Foreign Application Priority Data
Mar. 16, 2004 (AU) 2004901319
Jun. 20, 2004 (AU) 2004202693

(51) Int. Cl. G06Q 99/00

(52) U.S. Cl. 705/1

(57) ABSTRACT

A method of, and apparatus for generating an environmental management plan for management of golf courses is described. A game is also described which, when played, generates the environmental management plan. In the method, apparatus and game, a set of tasks and sub-tasks are associated with holes and strokes respectively in a game of golf so that a user or player may easily step through the generation of an environmental management plan which complies with a selected environmental management standard and world's best practice for managing golf course environments. Content for completing the plan is provided, documents are generated, and assistance is given in customising and completing each document. The game and method is typically conducted by a processing system. A progress indicator is also provided which is in the form of an animated golfer who executes the strokes associated with the sub-tasks, which facilitates improved motivation to complete the management plan.

### CROSS REFERENCE TO RELATED CO-PENDING APPLICATION

This application is a continuation of international PCT application number PCT/AU2004/000876 (publication number: WO 2005/091168 A1) filed on Jun. 22, 2004, and entitled EDUCATIONAL GAME WITH ENVIRONMENTAL THEME AND GOLF COURSE LAYOUT, which claims priority to Australian patent application number 2004901319 filed on Mar. 16, 2004, and Australian patent application number 2004202693 filed on Jun. 20, 2004, the contents of which are all expressly incorporated herein by reference.

### COPYRIGHT

A portion of the disclosure of this patent document contains material that is subject to copyright protection. The copyright owner has no objection to the facsimile reproduction by anyone of the patent disclosure, as it appears in a Patent Office patent files or records, but otherwise reserves all copyrights whatsoever.

### BACKGROUND OF THE INVENTION

The present invention relates generally to a method and apparatus for preparing environmental management plans, and in particular to a method and apparatus for preparing environmental management plans for the environmental management of golf courses by assigning a shot on a hole of a selected metaphorical golf course to each of a plurality of steps in the completion of each plan so that a user may immediately assess the number of steps to completion of the plan.

### DESCRIPTION OF THE PRIOR ART

The reference to any prior art in this specification is not, and should not be taken as, an acknowledgment or any form of suggestion that the prior art forms part of the common general knowledge.

It is known to prepare environmental plans which comply with published standards. However, preparing these plans, and motivating staff to prepare the plans, is extremely difficult and time consuming, at least partly because of the length of the plan required, means the plan takes many months to complete, the complexity of the language used, the different skill sets required to complete the plan, and the mental focus and discipline required of staff to complete the plan.

Furthermore, because of the known complexity of environmental plans, those charged with preparing the plan, a golf course superintendent, were having difficulty comprehending and motivating themselves to prepare the plans.

The present invention seeks to ameliorate one or more of the abovementioned disadvantages.

### SUMMARY OF THE PRESENT INVENTION

In a first broad form the present invention provides a method of preparing an environmental management policy or plan for implementation in the environmental management of a golf course, the environmental management policy comprising a selected plurality of critical tasks and sub-tasks to comply with a selected environmental management standard, the method using a processing system and comprising the steps of, in the processing system:
a) displaying on a display, simultaneously or in a selected sequence, a plurality of holes and/or associated strokes for playing a game of golf;
b) associating each critical task with a selected hole in the golf game;
c) associating a selected number of sub-tasks which are required to complete a respective critical task, with a stroke of a respective hole;
d) causing information and instructions associated with each sub-task to be displayed on at least the display when the stroke is selected to be played.

It may be that the player may select a hole and/or stroke to play from a menu or other selection tool. However, typically, the method comprises, in the processing system, the step of causing the display of a selected playing area on the display so that a hole may be selected by a user from a plurality of holes. Typically the playing area is a representation of a golf course or a golf hole.

Typically the method comprises, in the processing system, the step of displaying 18 tasks in a selected sequence corresponding with 18 holes in the representation of the golf course.

Typically the method comprises, in the processing system, the step of providing between 3 and 5 sub-tasks for each task, so that each hole is between par 3 and par 5.

Typically the method comprises, in the processing system, the step of providing linked documents or links to documents and/or templates and/or worked examples and/or case studies stored on a storage device connected to the processing system.

Typically the method comprises, in the processing system, the step of keeping and/or displaying a first tally or score relating to the number of completed tasks or sub-tasks in the selected environmental compliance plan, by completing a scorecard associated with the golf game.

Typically the method comprises, in the processing system, the step of keeping and updating a second tally of uncompleted tasks or sub-tasks in a memory or storage device connected to the processing system.

Typically the method comprises, in the processing system, the step of evaluating a ratio of uncompleted tasks or sub-tasks to competed tasks or sub-tasks to assess compliance of the environmental management plan with the selected environmental management standard.

Typically the method comprises, in the processing system, the step of generating forms and documents in response to player answers to instructions posed in a previous step.

Typically the method comprises, in the processing system, the step of displaying a progress indicator on the display device, the progress indicator being an animation of a golf player playing the stroke associated with the relevant sub-task being undertaken on one of the holes. This augment's the player's own knowledge of their progress through the preparation of the environmental management policy and plan, by giving a visual indication in a dedicated portion of the display device. That is, all golfers would know exactly how many holes they have to play after they have just completed, say, the 8^{th} hole. The indicator simply adds to that knowledge, so the player knows how many tasks must be completed before they complete the preparation of the environmental management policy.

In a second broad form the present invention provides apparatus for preparing an environmental management plan for implementation in the environmental management of a golf course, the apparatus comprising a processing system and a display device for:
(i) displaying a plurality of holes and associated strokes either simultaneously or in a selected sequence, for playing a game of golf;
(ii) associating each critical task with a selected hole in the golf game;
(iii)associating a selected number of sub-tasks which are required to complete a respective critical task, with a stroke of a respective hole;
(iv) causing content and instructions associated with each sub-task to be displayed on at least the display device when the stroke is selected to be played.

In a third broad form the present invention provides a game for preparing an environmental management policy or plan to manage a golf course which complies with a selected environmental management standard, the game comprising: a playing area in the form of a metaphorical golf course; a plurality of rules which govern progression through the metaphorical golf course by completing each hole, the plurality of rules requiring progression through the metaphorical golf course be contingent upon completion of a number of tasks and sub-tasks in the environmental management policy, each task associated with a respective hole on the metaphorical golf course.

Typically the game is conducted by a processing system connected to one or more input/output devices in the form of a keyboard, mouse and screen. Typically the processing system is connected to a memory and a storage area, and a printer.

Typically, during a hole of the game, game players are presented with content on the display. The content comprises in some embodiments, a series of questions, or forms and templates relating to, for example, the environment around the actual golf course for which the environmental management policy or plan is being generated, or staff levels of training for environmental storage, environmental hazards, and risk management of hazards. Players in some holes, complete the holes and therefore respective tasks in the generation of the plan by undergoing training provided by the content shown on the display, such as legislation governing various environmental aspects of golf course management, or where to store certain documents, and/or where to store certain chemicals. Players will, in some holes, be trained in how to create and manage databases of various items such as Objectives for environmental targets and the like.

The processing system provides templates and leaves various spaces in each field so that the player may complete the templates in a manner which is customised to the golf course which they manage.

Typically the game comprises an electronically linked environmental scorecard so that a player may be aware of how many holes he has satisfactorily completed. Typically the scorecard is stored in the memory and/or storage device, so that the player may partially complete the game in one session and then save their progression at the partially completed stage and return to the game at a later date.

Typically the game comprises an animated progress indicator that is in the form of a golfer who undertakes each stroke and progresses along the hole as each stroke is completed. This has the effect of motivating the player to complete the next stroke and thus strive to complete the management plan. Encouraging audio such as crowds clapping a difficult bunker shot for example may be played at various intervals to maintain the motivation of the player.

Typically the game comprises 18 holes, which represent 18 elements of an environmental management plan which meets world's best practice for environmental management.

### BRIEF DESCRIPTION OF THE DRAWINGS

An example of the present invention will now be described with reference to the accompanying drawings, in which:—

FIG. 1 is a schematic of a system for effecting the game and method;

FIG. 2 is a flowchart of an example of a process for;

### DETAILED DESCRIPTION OF THE PREFERRED EMBODIMENTS

The following description, given by way of example only, is given in order to provide a more precise understanding of the subject matter of a preferred embodiment or embodiments.

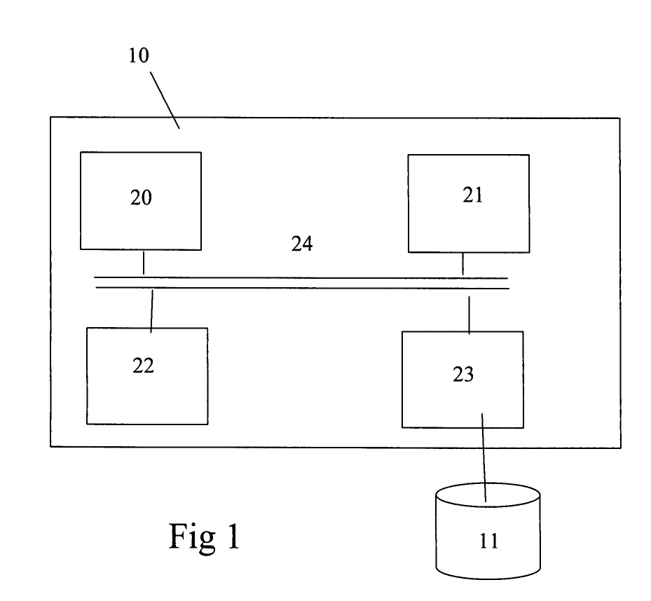

An example of an architecture for preparation of an environmental management plan for environmental management of golf courses is shown in FIG. 1. The architecture is also used for playing a game which assists in the preparation of the environmental management plan for golf courses.

An example of a processing system 10 is shown in FIG. 1. As shown the processing system 10 comprises a processor 20, a memory 21, an input/output device 22, such as a keyboard and display or the like, and an external interface 23, coupled together via a bus 24. In use the external interface 23 may be coupled to the database 11. A printer may be included in the processing system.

Accordingly, the processing system 10 may be any form of processing system, such as a computer server, a network server, a web server, a desktop computer, a lap-top or the like. Alternative specialised hardware may be used.

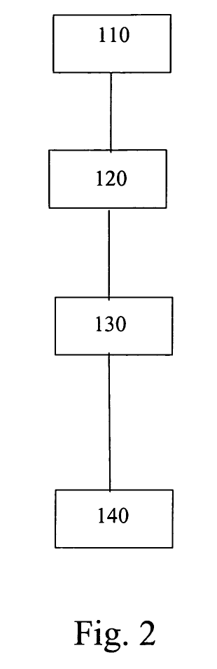

Referring now to FIG. 2, there is illustrated a flow chart showing an example in broad form, of a method of preparing an environmental management plan or policy in a processing system.

In particular, at step 110 the method comprises displaying simultaneously or in a selected sequence, a plurality of holes and/or associated strokes for playing a game of golf. At step 120 the method comprises associating each critical task with a selected hole in the golf game. At step 130 the method associates a selected number of sub-tasks which are required to complete a respective critical task, with a stroke of a respective hole. Finally, at step 140, a display step is taken wherein information and instructions associated with each sub-task is displayed when the stroke is selected to be played.

That is, the method involves a game of golf which is played on a playing area by a player wherein the holes and strokes of the game correspond with the tasks and sub-tasks to be undertaken in the generation of an environmental management plan. This method breaks down the huge number of seemingly incomprehensible documents and requirements of an international environmental management standard to a plurality of easily accessible tasks and sub-tasks which may be taken at any time and at any pace. The method uses a metaphor of playing a game of golf in order to generate an environmental management plan which complies with a selected international standard (in this case ISO14001).

The method allows a person who is familiar with the game of golf (such as golf course superintendents) to immediately ascertain whereabouts in the management plan generation they are, and how many steps there may be to complete the plan. For example, the superintendent (the player) may see that they have completed the 8^{th} hole and they then can see that they have only 10 holes to go before the management plan is complete.

The method includes the step of displaying content which instructs and trains and assists with the completion of specific environmental management planning tasks. The content includes, for example, information regarding Emergency Response and facilitates the completion and preparation of an Emergency Preparedness and Response Matrix, as well as Standard Operating Procedures for Operational Control of washbays, storage of chemicals and fuel, irrigation, waste management, spills, construction and renovation and the like. Environmental Training matrices are presented and instructions are given in their generation. Examples of Environmental Risk Registers are displayed and instructions are given in their preparation. Monitoring of the abovementioned factors is facilitated, and diarising of monitoring of certain events such as training, updates in laws, review of operational controls and emergency training responses is instructed and in some embodiments conducted. The abovementioned content is accessed by electronic links to documents stored in the processing system which may be printed and stored in hard copy registers separate from the processing system, or stored in the processing system itself.

The holes displayed on the playing area of the metaphorical golf course correspond with the following tasks in the preparation of the environmental plan:
Hole 1. Initial Environmental Review.
Hole 2. Environmental policy.
Hole 3. Environmental Aspects and impacts.
Hole 4. Legal and other requirements.
Hole 5. Environmental Objectives and Targets.
Hole 6. Environmental Action Plans.
Hole 7. Structure and responsibility.
Hole 8. Environmental Training Awareness and Competence.
Hole 9. Communication.
Hole 10. Environmental Management Program Documentation.
Hole 11. Document Control
Hole 12. Operational controls
Hole 13. Emergency response.
Hole 14. Monitoring and measuring.
Hole 15. Non-conformance and corrective and preventive actions.
Hole 16. Records,
Hole 17. Audit.
Hole 18. Management review.

The playing area of 18 holes is displayed on a monitor, and movement of the input device (mouse) highlights certain holes which may be played in any order in order to generate the management plan. Preferably, the holes are played from 1 to 18, but if a player becomes stuck they may move onto another hole and return to the difficult hole at a later stage.

The method further includes the step of displaying a progress indicator in the form of an animated golf player and golf ball which may be seen to execute the stroke which has just been completed. This increases motivation of the user and encourages the progression to the next task.

The method further includes the step of displaying an environmental scorecard which, again corresponds with a golf scorecard in the method or game being played. The scorecard provides a further quick reckoning of the progress through the preparation of the plan.

The method may be effected by a processing system and the game played on a processing system.

Some holes are designated par 3 and others par 4 and others par 5. This indicates the degree of difficulty of the hole and shows a person at a glance how much effort is required before entering into the tasks and sub-tasks required to complete the task. The par-indicator also corresponds with the number of sub-tasks associated with that hole. Thus, par 5 holes have 5 sub-tasks to complete before the task is completed.

Persons skilled in the art will appreciate that numerous variations and modifications will become apparent. All such variations and modifications which become apparent to persons skilled in the art, should be considered to fall within the spirit and scope that the invention broadly appearing before described.

I claim:

1. A method of preparing an environmental management policy or plan for implementation in the environmental management of a golf course, the environmental management policy comprising a selected plurality of critical tasks and sub-tasks to comply with a selected environmental management standard, the method using a processing system and comprising the steps of, in the processing system:
a) displaying, simultaneously or in a selected sequence, a plurality of holes and/or associated strokes for playing a game of golf,
b) associating each critical task with a selected hole in the golf game;
c) associating a selected number of sub-tasks which are required to complete a respective critical task, with a stroke of a respective hole;
d) displaying information and instructions associated with each sub-task when the stroke is selected to be played.

2. The method in accordance with claim 1 comprising, in the processing system, the step of displaying a selected playing area so that in use a hole or stroke is selected by a user from a plurality of holes or strokes wherein the playing area is a representation of a golf course or a golf hole.

3. The method in accordance with claim 1 comprising, in the processing system, the step of providing 18 tasks corresponding with 18 holes and between 3 and 5 sub-tasks for each task, so that each hole is between par 3 and par 5.

4. The method in accordance with claim 1 comprising, in the processing system, the step of providing linked content or documents or links to content or documents and/or templates and/or worked examples and/or case studies stored on a storage device connected to the processing system.

5. The method in accordance with claim 1 comprising, in the processing system, the step of keeping and/or displaying a first tally or score relating to the number of completed tasks or sub-tasks in the selected environmental compliance plan, by completing a scorecard associated with the golf game.

6. The method in accordance with claim 1 comprising, in the processing system, the step of keeping and updating a second tally of incomplete tasks or sub-tasks in a memory or storage device connected to the processing system.

7. The method in accordance with claim 1 comprising, in the processing system, the step of evaluating a ratio of incomplete tasks or sub-tasks to completed tasks or sub-tasks to assess compliance of the environmental management plan with the selected environmental management standard.

8. The method in accordance with claim 1 comprising, in the processing system, the step of generating forms and documents in response to player answers to instructions posed in a previous step.

9. The method in accordance with claim 1 comprising, in the processing system, the step of displaying a progress indicator on the display device, the progress indicator being an animation of a golf player playing the stroke associated with the relevant sub-task being undertaken on one of the holes.

10. An apparatus for preparing an environmental management plan for implementation in the environmental management of a golf course, the apparatus comprising a processing system for:
(i) displaying a plurality of holes and associated strokes either simultaneously or in a selected sequence, for playing a game of golf;
(ii) associating each critical task with a selected hole in the golf game;
(iii) associating a selected number of sub-tasks which are required to complete a respective critical task, with a stroke of a respective hole;
(iv) causing content and instructions associated with each sub-task to be displayed when the stroke is selected to be played.

11. A game for preparing an environmental management policy or plan to manage a golf course which complies with a selected environmental management standard, the game comprising: a playing area in the form of a metaphorical golf course; a plurality of rules which govern progression through the metaphorical golf course by completing each hole, the plurality of rules requiring progression through the metaphorical golf course be contingent upon completion of a number of tasks and sub-tasks in the environmental management policy, each task associated with a respective hole on the metaphorical golf course.

12. The game in accordance with claim 11 comprising a processing system which enables and controls play of the game and, during play of a hole of the game, presents players with a playing area and content for completing a task.

13. The game in accordance with claim 12 wherein templates are provided so that the player during play may customise the environmental management plan to the golf course which they are managing.

14. The game in accordance with claim 11 comprising an electronically linked environmental scorecard so that a player may be aware of how many holes he has satisfactorily completed.

15. The game in accordance with claim 11 wherein the scorecard is stored in the processing system so that the player may partially complete the game in one session and then save their progression at the partially completed stage and return to the game at a later date.

16. The game in accordance with claim 11 comprising an animated progress indicator that is in the form of an animated golfer who executes each metaphorical stroke associated with the sub-task and progresses along the hole as each sub-task is completed.
